(19) United States
(12) Patent Application Publication
(10) Pub. No.: US 2026/0332178 A1
(43) Pub. Date: Oct. 22, 2026

(54) Transmitter with Spurious Emission Mitigation

(71) Applicant: Apple Inc., Cupertino, CA (US)

(72) Inventors: Ming-Da Tsai, San Jose, CA (US); Ankit Srivastava, San Diego, CA (US)

(21) Appl. No.: 19/183,334

(22) Filed: Apr. 18, 2025

(51) Int. Cl. H04B 1/10

(52) U.S. Cl. CPC H04B 1/10

(57) ABSTRACT

An electronic device may be provided with wireless circuitry that includes a transmit path. The transmit path may include a digital-to-analog converter (DAC), a multi-phase mixer, a non-linear component, and a vector interpolator. The DAC may output an in-phase and quadrature-phase (I/Q) baseband signal. The vector interpolator may output eight different phases of a baseband signal separated by 45 degrees based on the I/Q baseband signal. The mixer may include a set of eight switches coupled in parallel between the vector interpolator and the non-linear component. Each switch may receive a respective one of the eight phases of baseband signal and may be toggled by a respective one of eight different equal magnitude phases of a local oscillator signal. This may cancel out components from the transmitted signal that would otherwise produce spurious emissions such as CIM3 and CIM5 emissions.

### FIELD

This disclosure relates generally to electronic devices, including electronic devices with communications circuitry.

### BACKGROUND

Electronic devices are often provided with communications capabilities. An electronic device with communications capabilities includes communications circuitry with a transmitter that transmits radio-frequency signals. If care is not taken, non-linearity in the transmitter can produce spurious emissions that deteriorate wireless performance of the transmitter.

### SUMMARY

An electronic device may be provided with wireless circuitry. The wireless circuitry may include a transmit path. The transmit path may include a digital-to-analog converter (DAC), analog baseband (ABB) circuitry coupled to an output of the DAC, a multi-phase mixer coupled to an output of the ABB circuitry, and a non-linear component such as a radio-frequency programmable gain amplifier (RPGA) coupled to an output of the multi-phase mixer. The ABB circuitry may include a baseband filter, a vector interpolator, and a baseband programmable gain amplifier (BBPGA) coupled in series between the DAC and the multi-phase mixer. If desired, the vector interpolator and the BBPGA may be integrated into a combined circuit that performs the functions of both the vector interpolator and the BBPGA.

The DAC may output an in-phase and quadrature-phase (I/Q) baseband signal. The baseband filter may filter the I/Q baseband signal to produce four different respective phases of a filtered signal that are equally spaced by 90 degrees. The vector interpolator may output eight different phases of a baseband signal by interpolating the four different phases of the filtered signal. The eight different phases of the baseband signal may be equally spaced by 45 degrees. The multi-phase mixer may include a set of eight switches coupled in parallel between the ABB circuitry and the RPGA. Each switch may receive a respective one of the eight phases of baseband signal output by the vector interpolator. Each switch may be toggled by a respective one of eight different equal magnitude phases of a local oscillator signal. The eight different equal magnitude phases of the local oscillator signal may be equally spaced by 45 degrees. When implemented in this way, the TX path may cancel out signal components from the radio-frequency signal that would otherwise produce spurious emissions after amplification by the RPGA, such as CIM3 and/or CIM5 emissions.

An aspect of the disclosure provides wireless circuitry. The wireless circuitry can include a digital-to-analog converter (DAC). The wireless circuitry can include a vector interpolator having an input communicatively coupled to an output of the DAC. The wireless circuitry can include a multi-phase mixer having an input communicatively coupled to an output of the vector interpolator. The wireless circuitry can include a non-linear component having an input communicatively coupled to an output of the multi-phase mixer.

An aspect of the disclosure provides wireless circuitry. The wireless circuitry can include a digital-to-analog converter configured to output an in-phase and quadrature-phase (I/Q) baseband signal. The wireless circuitry can include a vector interpolator communicatively coupled to an output of the DAC and configured to output eight phases of a baseband signal based on the (I/Q) baseband signal. The wireless circuitry can include a radio-frequency amplifier. The wireless circuitry can include a multi-phase mixer that includes a set of eight switches coupled in parallel between the vector interpolator and the radio-frequency amplifier, wherein each switch in the set of eight switches is configured to receive a different respective one of the eight phases of the baseband signal output by the vector interpolator. The wireless circuitry can include local oscillator circuitry configured to generate eight equal magnitude phases of a local oscillator signal, wherein each switch in the set of eight switches is toggled by a different respective one of the eight equal magnitude phases of the local oscillator signal.

An aspect of the disclosure provides a radio-frequency transmitter. The radio-frequency transmitter can include a baseband filter configured to output four different phases of a baseband signal. The radio-frequency transmitter can include a vector interpolator communicatively coupled to the baseband filter and configured to output eight different phases of the baseband signal based on the four different phases of the baseband signal output by the baseband filter, wherein the eight different phases of the baseband signal are equally separated by 45 degrees. The radio-frequency transmitter can include an eight-phase mixer communicatively coupled to the vector interpolator and configured to generate a radio-frequency signal based on the eight different phases of the baseband signal and eight different equal magnitude phases of a local oscillator signal, wherein the eight different equal magnitude phases of the local oscillator signal are equally separated by 45 degrees.

### BRIEF DESCRIPTION OF THE DRAWINGS

FIG. 1 is a diagram of an illustrative electronic device having wireless circuitry in accordance with some embodiments.

FIG. 2 is a diagram of illustrative wireless circuitry having a transceiver in accordance with some embodiments.

FIG. 3 is a circuit diagram of illustrative wireless circuitry with a transmit path that includes a vector interpolator for mitigating spurious emissions in accordance with some embodiments.

FIG. 4 is a circuit diagram of an illustrative vector interpolator in accordance with some embodiments.

FIG. 5 includes in-phase and quadrature-phase (I/Q) diagrams showing how an illustrative vector interpolator of the type shown in FIGS. 3 and 4 may produce cancellation of third order counter-intermodulation (CIM3) in accordance with some embodiments.

FIG. 6 is a plot illustrating how a vector interpolator of the type shown in FIGS. 3 and 4 may reduce spurious emissions in accordance with some embodiments.

FIG. 7 is a circuit diagram of illustrative analog baseband circuitry that includes integrated vector interpolator and baseband programmable gain amplifier circuitry driven by filter circuitry in accordance with some embodiments.

FIG. 8 is a circuit diagram of illustrative filter circuitry of the type shown in FIG. 7 in accordance with some embodiments.

FIGS. 9 and 10 are diagrams showing different illustrative locations for a vector interpolator in analog baseband circuitry in accordance with some embodiments.

### DETAILED DESCRIPTION

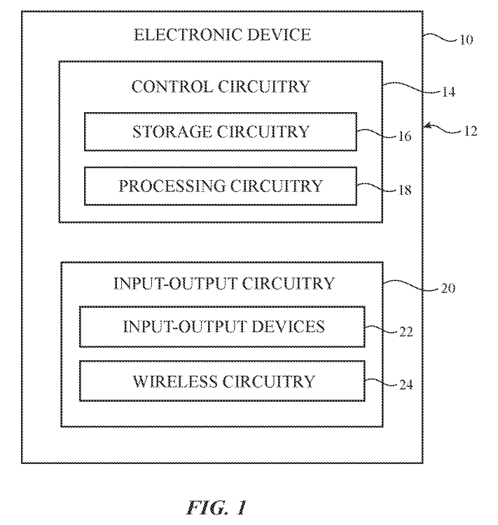

FIG. 1 is a block diagram of an electronic device 10 that may be provided with communications circuitry. Device 10 may be a computing device such as a laptop computer, a desktop computer, a computer monitor (e.g., containing an embedded computer), a tablet computer, a cellular telephone, a media player, or another handheld or portable electronic device, a smaller device such as a wristwatch device, a pendant device, a headphone or earpiece device, a device embedded in eyeglasses, goggles, a helmet, or other equipment worn on a user’s head (e.g., an augmented, virtual, or mixed reality head-mounted display device), or another wearable or miniature device, a television, a computer display (e.g., that does not contain an embedded computer), a gaming device, a navigation device, an embedded system such as a system in which electronic equipment with a display is mounted in a kiosk or automobile, a wireless internet-connected voice-controlled speaker, a home entertainment device, a remote control device, a gaming controller, a peripheral user input device, a wireless base station or access point, equipment that implements the functionality of two or more of these devices, or other electronic equipment.

As shown in the functional block diagram of FIG. 1, device 10 may include components located on or within an electronic device housing such as housing 12. Housing 12, which may sometimes be referred to as a case, may be formed from plastic, glass, ceramics, fiber composites, metal (e.g., stainless steel, aluminum, metal alloys, etc.), other suitable materials, or a combination of these materials. In some embodiments, some or all of housing 12 may be formed from dielectric or other low-conductivity material (e.g., glass, ceramic, plastic, sapphire, etc.). In other embodiments, housing 12 or at least some of the structures that make up housing 12 may be formed from metal elements.

Device 10 may include control circuitry 14. Control circuitry 14 may include storage such as storage circuitry 16. Storage circuitry 16 may include hard disk drive storage, nonvolatile memory (e.g., flash memory or other electrically-programmable-read-only memory configured to form a solid-state drive), volatile memory (e.g., static or dynamic random-access-memory), etc. Storage circuitry 16 may include storage that is integrated within device 10 and/or removable storage media.

Control circuitry 14 may include processing circuitry such as processing circuitry 18. Processing circuitry 18 may be used to control the operation of device 10. Processing circuitry 18 may include on one or more processors such as microprocessors, microcontrollers, digital signal processors, host processors, baseband processor integrated circuits, application specific integrated circuits, central processing units (CPUs), application processors, graphics processing units (GPUs), etc. Control circuitry 14 may be configured to perform operations in device 10 using hardware (e.g., dedicated hardware or circuitry), firmware, and/or software. Software code for performing operations in device 10 may be stored on storage circuitry 16 (e.g., storage circuitry 16 may include non-transitory (tangible) computer readable storage media that stores the software code). The software code may sometimes be referred to as program instructions, software, data, instructions, or code. Software code stored on storage circuitry 16 may be executed by processing circuitry 18.

Control circuitry 14 may be used to run software on device 10 such as satellite navigation applications, internet browsing applications, voice-over-internet-protocol (VOIP) telephone call applications, email applications, media playback applications, operating system functions, etc. To support interactions with external equipment, control circuitry 14 may be used in implementing wireless communications protocols (sometimes also referred to as communications protocols or communications standards). Communications protocols (standards) that may be implemented using control circuitry 14 include wireless local area network (WLAN) protocols (e.g., IEEE 802.11 protocols – sometimes referred to as Wi-Fi® such as a Wi-Fi 6 protocol, a Wi-Fi 7 protocol, or other Wi-Fi protocols), protocols for other short-range wireless communications links such as the Bluetooth® protocol or other wireless personal area network (WPAN) protocols, IEEE 802.11ad protocols (e.g., ultra-wideband protocols), cellular telephone protocols (e.g., 3G protocols, 4G (LTE) protocols, 3GPP Fifth Generation (5G) New Radio (NR) protocols, Sixth Generation (6G) protocols, sub-THz protocols, THz protocols, etc.), satellite navigation system protocols (e.g., global positioning system (GPS) protocols, global navigation satellite system (GLONASS) protocols, etc.), satellite communications (satcom) protocols, antenna-based spatial ranging protocols, optical communications protocols, or any other desired communications protocols. Each communications protocol may be associated with a corresponding radio access technology (RAT) that specifies the physical connection methodology used in implementing the protocol (e.g., used in transmitting and/or receiving radio-frequency signals under or according to the protocol).

Device 10 may include input-output circuitry 20. Input-output circuitry 20 may include input-output devices 22. Input-output devices 22 may be used to allow data to be supplied to device 10 and to allow data to be provided from device 10 to external devices. Input-output devices 22 may include user interface devices, data port devices, and other input-output components. For example, input-output devices 22 may include touch sensors, displays (e.g., touch-sensitive and/or force-sensitive displays), light-emitting components such as displays without touch sensor capabilities, buttons (mechanical, capacitive, optical, etc.), scrolling wheels, touch pads, key pads, keyboards, microphones, cameras, buttons, speakers, status indicators, audio jacks and other audio port components, digital data port devices, motion sensors (accelerometers, gyroscopes, and/or compasses that detect motion), capacitance sensors, proximity sensors, magnetic sensors, force sensors (e.g., force sensors coupled to a display to detect pressure applied to the display), etc. In some configurations, keyboards, headphones, displays, pointing devices such as trackpads, mice, and joysticks, and other input-output devices may be coupled to device 10 using wired or wireless connections (e.g., some of input-output devices 22 may be peripherals that are coupled to a main processing unit or other portion of device 10 via a wired or wireless link).

Input-output circuitry 20 may include communications circuitry that supports communications between components of device 10 and/or between device 10 and one or more external devices. The communications circuitry may include wired communications circuitry that conveys signals via one or more wired communications links over one or more wired paths (e.g., optical fiber paths, Ethernet paths, coaxial cable paths, conductive lines, serial paths, digital paths, analog paths, data paths, signal paths, interconnects, ports, etc.). Additionally, or alternatively, the communications circuitry may include wireless circuitry 24 that supports wireless communications (e.g., communications using wireless radio-frequency signals). Wireless circuitry 24 (sometimes referred to herein as wireless communications circuitry 24) may include one or more antennas. Wireless circuitry 24 may also include baseband processor circuitry, transceiver circuitry, amplifier circuitry, filter circuitry, switching circuitry, radio-frequency transmission lines, and/or any other circuitry for transmitting and/or receiving radio-frequency signals using the antenna(s).

Wireless communications performed by wireless circuitry 24 may include or involve wireless data communications (e.g., where wireless data is carried by radio-frequency signals conveyed between wireless circuitry 24 and other communications equipment bidirectionally or unidirectionally), radio-frequency signal transmission, radio-frequency signal reception, and/or radio-based spatial ranging/sensing (e.g., radio detection and ranging (radar) operations, shorter range object detection such as near-field radio-frequency signal-based object detection, etc.). Radio-frequency signals conveyed by wireless circuitry 24 may include or carry wireless data (e.g., organized into frames, packets, symbols, datagrams, etc.), radar or other spatial ranging waveforms, continuous wave signals, chirp signals, control signals, management signals, reference signals, beacon signals, tones, pulses/impulses, waveforms associated with one or more communications protocols, and/or any other radio-frequency waveforms or signals. Wireless circuitry 24 is sometimes also referred to herein as wireless communications circuitry 24, wireless communication circuitry 24, communications circuitry 24, or simply as circuitry 24. Wireless circuitry 24 may include one or more antennas. Wireless circuitry 24 may also include baseband processor circuitry, transceiver circuitry, amplifier circuitry, filter circuitry, switching circuitry, radio-frequency transmission lines, and/or any other circuitry for transmitting and/or receiving radio-frequency signals using the antenna(s). Some or all of the components of wireless circuitry 24 may be disposed on, mounted to, communicatively coupled to, and/or integrated within the same substrate (e.g., a printed circuit board, semiconductor substrate, chip, integrated circuit (IC), IC packages, etc.) or may be distributed between two or more substrates (e.g., printed circuit boards, semiconductor substrates, chips, ICs, IC packages, etc.). Some or all of the signal generation, transmission, and/or reception operations described herein as being performed by wireless circuitry 24 may alternatively be performed by wired communications circuitry in input-output circuitry 20.

Wireless circuitry 24 may transmit and/or receive radio-frequency signals within a corresponding frequency band at radio frequencies (sometimes referred to herein as a communications band or simply as a “band”). The frequency bands handled by wireless circuitry 24 may include wireless local area network (WLAN) frequency bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), a Wi-Fi® 7 band, and/or other Wi-Fi® bands (e.g., from 1875-5160 MHz), wireless personal area network (WPAN) frequency bands such as the 2.4 GHz Bluetooth® band or other WPAN communications bands, cellular telephone frequency bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, etc.), other centimeter or millimeter wave frequency bands between 10-100 GHz, sub-THz frequency bands between around 100 GHz and 10 THz (e.g., 6G bands), near-field communications (NFC) frequency bands (e.g., at 13.56 MHz), satellite navigation frequency bands (e.g., a GPS band from 1565 to 1610 MHz, a Global Navigation Satellite System (GLONASS) band, a BeiDou Navigation Satellite System (BDS) band, etc.), ultra-wideband (UWB) frequency bands that operate under the IEEE 802.15.4 protocol and/or other ultra-wideband communications protocols, satellite communications (satcom) bands (e.g., an IEEE C band (4-8 GHz), S band (2-4 GHz), L band (1-2 GHz), X band (8-12 GHz), W band (75-110 GHz), V band (40-75 GHz), K band (18-27 GHz), Kₐ band (26.5-40 GHz), Kᵤ band (12-18 GHz), etc.), unlicensed bands, communications bands under the family of 3GPP wireless communications standards, communications bands under the IEEE 802.XX family of standards, and/or any other desired frequency bands of interest. Different communications protocols may utilize different frequency bands for conveying radio-frequency signals. In some cases, two or more communications protocols may utilize one or more of the same frequency bands for conveying radio-frequency signals.

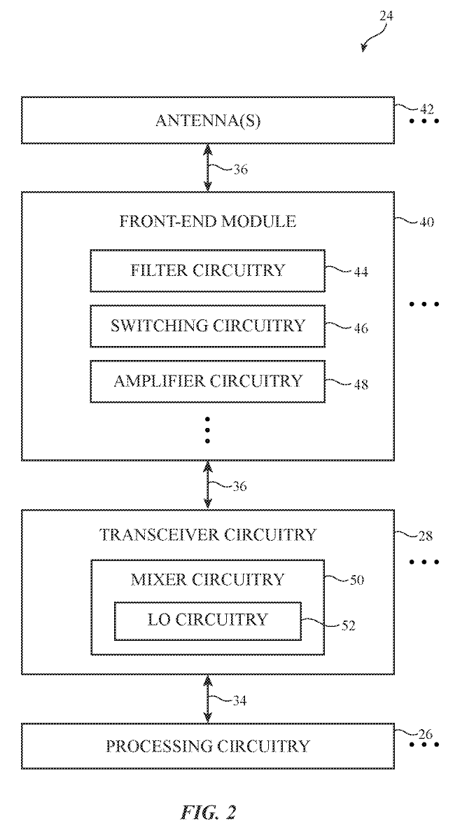

FIG. 2 is a diagram showing illustrative components within wireless circuitry 24. As shown in FIG. 2, wireless circuitry 24 may include processing circuitry 26, radio-frequency (RF) transceiver circuitry 28, radio-frequency front end circuitry such as radio-frequency front end (RFFE) module (FEM) 40, and antenna(s) 42. Processing circuitry 26 may include one or more baseband processors, application processors, general purpose processors, microprocessors, microcontrollers, digital signal processors, host processors, application specific signal processing hardware, and/or other types of processors. Processing circuitry 26 may be communicatively coupled to transceiver circuitry 28 over path 34. Transceiver circuitry 28 may be coupled to antenna 42 via radio-frequency transmission line path 36. Radio-frequency front end module 40 may be disposed on radio-frequency transmission line path 36 between transceiver circuitry 28 and antenna 42.

Transceiver circuitry 28 may include one or more transceivers. Each transceiver may include a transmitter and/or a receiver. In the example of FIG. 2, wireless circuitry 24 is illustrated as including only a single front end module 40 and a single antenna 42 for the sake of clarity. In general, wireless circuitry 24 may include any desired number of front end modules 40 and any desired number of antennas 42. If desired, processing circuitry 26 may be coupled to one or more transceivers in transceiver circuitry 28 over respective paths 34. Each transceiver may include a transmitter configured to output uplink signals to antenna 42 and/or a receiver configured to receive downlink signals from antenna 42. Each transceiver may be coupled to one or more antennas 42 over respective radio-frequency transmission line paths 36. Each radio-frequency transmission line path 36 may have a respective front end module 40 disposed thereon. If desired, two or more front end modules 40 may be disposed on the same radio-frequency transmission line path 36. If desired, one or more of the radio-frequency transmission line paths 36 in wireless circuitry 24 may be implemented without any front end module disposed thereon.

Radio-frequency transmission line path 36 may be coupled to an antenna feed on antenna 42. The antenna feed may, for example, include a positive antenna feed terminal and a ground antenna feed terminal. Radio-frequency transmission line path 36 may have a positive transmission line signal path that is coupled to the positive antenna feed terminal on antenna 42. Radio-frequency transmission line path 36 may have a ground transmission line signal path that is coupled to the ground antenna feed terminal on antenna 42. This example is illustrative and, in general, antennas 42 may be fed using any desired antenna feeding scheme. If desired, antenna 42 may have multiple antenna feeds that are coupled to one or more radio-frequency transmission line paths 36.

Radio-frequency transmission line path 36 may include transmission lines that are used to route radio-frequency antenna signals within device 10 (FIG. 1). Transmission lines in device 10 may include coaxial cables, microstrip transmission lines, stripline transmission lines, edge-coupled microstrip transmission lines, edge-coupled stripline transmission lines, transmission lines formed from combinations of transmission lines of these types, etc. Transmission lines in device 10 such as transmission lines in radio-frequency transmission line path 36 may be integrated into rigid and/or flexible printed circuit boards.

While performing wireless transmission, processing circuitry 26 may provide transmit signals (e.g., digital or baseband signals) to transceiver circuitry 28 over path 34. Transceiver circuitry 28 may further include circuitry for converting the transmit (baseband) signals received from processing circuitry 26. For example, transceiver circuitry 28 may include mixer circuitry 50 that up-converts (or modulates) the transmit (baseband) signals to radio frequencies prior to transmission over antenna 42. The example of FIG. 2 in which processing circuitry 26 communicates with transceiver circuitry 28 is illustrative. In general, transceiver circuitry 28 may communicate with a baseband processor, an application processor, general purpose processor, a microcontroller, a microprocessor, or one or more processors within processing circuitry 18 (FIG. 1). Transceiver circuitry 28 may also include digital-to-analog converter (DAC) and/or analog-to-digital converter (ADC) circuitry for converting signals between digital and analog domains. Transceiver circuitry 28 may include a transmitter that transmits the radio-frequency signals over antenna 42 via radio-frequency transmission line path 36 and front end module 40. Antenna 42 may transmit the radio-frequency signals to external wireless equipment by radiating the radio-frequency signals into free space.

While performing wireless reception, antenna 42 may receive radio-frequency signals from the external wireless equipment. The received radio-frequency signals may be conveyed to transceiver circuitry 28 via radio-frequency transmission line path 36 and front end module 40. Transceiver circuitry 28 may include circuitry a receiver that receives signals from front end module 40 and that converts the received radio-frequency signals into corresponding baseband signals. For example, mixer circuitry 50 in transceiver circuitry 28 may down-convert (or demodulate) the received radio-frequency signals to baseband frequencies prior to conveying the received signals to processing circuitry 26 over path 34.

Mixer circuitry 50 may include clocking circuitry such as local oscillator (LO) circuitry 52. Local oscillator circuitry 52 (sometimes also referred to as clock generation circuitry 52 or LO signal generation circuitry 52) may include one or more reference oscillators, crystal oscillators, voltage controlled oscillators, phase-locked loops, frequency-locked loops, self-injection locked loops, and/or other clock generation circuitry that generates oscillator (oscillating) signals. Mixer circuitry 50 may use the oscillator signals generated by local oscillator circuitry 52 to modulate (upconvert) transmitting signals from baseband frequencies to radio frequencies and/or to demodulate (downconvert) the received signals from radio frequencies to baseband frequencies. LO circuitry 52 may also generate oscillator signals that mixer circuitry 50 uses to upconvert intermediate frequency signals to radio-frequency signals, to upconvert baseband signals to intermediate frequency signals, to downconvert radio-frequency signals to intermediate frequency signals, and/or to downconvert intermediate frequency signals to baseband signals. Although LO circuitry 52 is illustrated as being included within mixer circuitry 50 in FIG. 2 for the sake of simplicity, LO circuitry 52 may, if desired, be implemented within transceiver circuitry 28 but external to mixer circuitry 50 or external to transceiver circuitry 28.

Front end module (FEM) 40 may include radio-frequency front end circuitry that operates on the radio-frequency signals conveyed over radio-frequency transmission line path 36. FEM 40 may, for example, include front end module components such as radio-frequency filter circuitry 44 (e.g., low pass filters, high pass filters, notch filters, band pass filters, multiplexing circuitry, duplexer circuitry, diplexer circuitry, triplexer circuitry, etc.), switching circuitry 46 (e.g., one or more radio-frequency switches), radio-frequency amplifier circuitry 48 (e.g., one or more power amplifiers and/or one or more low-noise amplifiers), signal attenuators, impedance matching circuitry (e.g., circuitry that helps to match the impedance of antenna 42 to the impedance of radio-frequency transmission line 36), antenna tuning circuitry (e.g., networks of capacitors, resistors, inductors, and/or switches that adjust the frequency response of antenna 42), radio-frequency coupler circuitry, charge pump circuitry, power management circuitry, digital control and interface circuitry, and/or any other desired circuitry that operates on the radio-frequency signals transmitted and/or received by antenna 42. Each of the front end module components may be mounted to a common (shared) substrate such as a rigid printed circuit board substrate or flexible printed circuit substrate. If desired, the various front end module components may also be integrated into a single integrated circuit chip. If desired, amplifier circuitry 48 and/or other components in FEM 40 such as filter circuitry 44 may also be implemented as part of transceiver circuitry 28.

Filter circuitry 44, switching circuitry 46, amplifier circuitry 48, and other circuitry may be disposed along radio-frequency transmission line path 36, may be incorporated into FEM 40, and/or may be incorporated into antenna 42 (e.g., to support antenna tuning, to support operation in desired frequency bands, etc.). These components, sometimes referred to herein as antenna tuning components, may be adjusted (e.g., using control circuitry 14) to tune the frequency response and wireless performance of antenna 42 over time.

Transceiver circuitry 28 may be separate from front end module 40. For example, transceiver circuitry 28 may be formed on another substrate such as the main logic board of device 10, a rigid printed circuit board, or flexible printed circuit that is not a part of front end module 40. Although control circuitry 14 is shown separately from wireless circuitry 24 in the example of FIG. 1 for the sake of clarity, wireless circuitry 24 may include processing circuitry that forms a part of processing circuitry 18 and/or storage circuitry that forms a part of storage circuitry 16 of control circuitry 14 (e.g., portions of control circuitry 14 may be implemented on wireless circuitry 24). As an example, processing circuitry 26 and/or portions of transceiver circuitry 28 (e.g., a host processor on transceiver 28) may form a part of control circuitry 14. Control circuitry 14 (e.g., portions of control circuitry 14 formed on processing circuitry 26, portions of control circuitry 14 formed on transceiver 28, and/or portions of control circuitry 14 that are separate from wireless circuitry 24) may provide control signals (e.g., over one or more control paths in device 10) that control the operation of front end module 40.

Transceiver circuitry 28 may include wireless local area network transceiver circuitry that handles WLAN communications bands (e.g., Wi-Fi® (IEEE 802.11) or other WLAN communications bands) such as a 2.4 GHz WLAN band (e.g., from 2400 to 2480 MHz), a 5 GHz WLAN band (e.g., from 5180 to 5825 MHz), a Wi-Fi® 6E band (e.g., from 5925-7125 MHz), and/or other Wi-Fi® bands (e.g., from 1875-5160 MHz), wireless personal area network transceiver circuitry that handles the 2.4 GHz Bluetooth® band or other WPAN communications bands, cellular telephone transceiver circuitry that handles cellular telephone bands (e.g., bands from about 600 MHz to about 5 GHz, 3G bands, 4G LTE bands, 5G New Radio Frequency Range 1 (FR1) bands below 10 GHz, 5G New Radio Frequency Range 2 (FR2) bands between 20 and 60 GHz, 6G bands above 100 GHz, etc.), near-field communications (NFC) transceiver circuitry that handles near-field communications bands (e.g., at 13.56 MHz), satellite navigation receiver circuitry that handles satellite navigation bands (e.g., a GPS band from 1565 to 1610 MHz, a Global Navigation Satellite System (GLONASS) band, a BeiDou Navigation Satellite System (BDS) band, etc.), ultra-wideband (UWB) transceiver circuitry that handles communications using the IEEE 802.15.4 protocol and/or other ultra-wideband or impulse-based communications protocols, and/or any other desired radio-frequency transceiver circuitry for covering any other desired communications bands of interest.

Antenna 42 may be formed using any desired antenna structures. For example, antenna 42 may be an antenna with a resonating element that is formed from loop antenna structures, patch antenna structures, inverted-F antenna structures, slot antenna structures, planar inverted-F antenna structures, helical antenna structures, monopole antennas, dipoles, hybrids of these designs, etc. Two or more antennas 42 may be arranged into one or more phased antenna arrays (e.g., for conveying radio-frequency signals at millimeter wave frequencies). Parasitic elements may be included in antenna 42 to adjust antenna performance. Antenna 42 may be provided with a conductive cavity that backs the antenna resonating element of antenna 42 (e.g., antenna 42 may be a cavity-backed antenna such as a cavity-backed slot antenna).

The term “convey radio-frequency signals” as used herein means the transmission and/or reception of the radio-frequency signals (e.g., for performing unidirectional and/or bidirectional wireless communications with external wireless communications equipment). Antennas 42 may transmit the radio-frequency signals by radiating the radio-frequency signals into free space (or to free space through intervening device structures such as a dielectric cover layer). Antennas 42 may additionally, or alternatively, receive the radio-frequency signals from free space (e.g., through intervening devices structures such as a dielectric cover layer). The transmission and reception of radio-frequency signals by antennas 42 each involve the excitation or resonance of antenna currents on an antenna resonating element in the antenna by the radio-frequency signals within the frequency band(s) of operation of the antenna.

Wireless circuitry 24 may include a transmit (TX) path (sometimes also referred to as a TX chain) from processing circuitry 26 to antenna 42. The TX path may include, for example, baseband circuitry (e.g., in processing circuitry 26), transmitter circuitry (e.g., in transceiver circuitry 28) that includes one or more mixers in mixer circuitry 50, FEM components in FEM 40, and a corresponding antenna 42 that are communicatively coupled together by path 34 and radio-frequency transmission line path 36. In practice, the TX path may include one or more non-linear components. Non-linear components in the TX path can produce undesired spurious emissions during signal transmission. If care is not taken, these spurious emissions can deteriorate the performance of wireless circuitry 24 in transmitting radio-frequency signals and/or can cause wireless circuitry 24 to violate one or more regulations or standards for radio-frequency emission/exposure.

When transmitting radio-frequency signals at certain frequencies (e.g., 5G NR FR1 frequencies), spurious emissions such as third order counter intermodulation (CIM3), fifth order counter intermodulation (CIM5), and/or emissions associated with third order harmonic distortion (HD3) can become particularly strong. During signal transmission, mixer circuitry 50 in the TX path may receive baseband signals at a corresponding baseband frequency fBB. LO circuitry 52 may supply a clocking signal such as a local oscillator signal to mixer circuitry 50 at a corresponding local oscillator frequency fLO. Mixer circuitry 50 upconverts the baseband signal to produce a radio-frequency signal that exhibits peak power at frequency fBB + fLO, and which may also include lower and upper sideband components at frequencies fLO - 3fBB and fLO + 5fBB. In addition, the radio-frequency signal may include power in a third order harmonic of the LO signal, at a frequency 3fLO – fBB.

When the radio-frequency signal is then amplified by a non-linear component in the TX path, such as a radio-frequency (RF) programmable gain amplifier (PGA) in amplifier circuitry 48 or in transceiver circuitry 28, non-linearity of the non-linear component can produce spurious emissions such as CIM3, CIM5, and/or other emissions. For example, CIM3 emission may be produced, at the non-linear component, by counter-intermodulation between the desired signal at frequency fLO + fBB and the third order harmonic of the LO signal at frequency 3fLO – fBB. On the other hand, CIM5 emission may be produced, for example, by counter-intermodulation between the desired signal at frequency fLO + fBB and the sideband signal at frequency fLO – 3fBB. If care is not taken, at least the CIM3 emission and/or the CIM5 emission can be sufficiently close to interfere with the desired signal at fLO + fBB (e.g., deteriorating the wireless performance of the TX path in transmitting the radio-frequency signal) and/or can be excessively powerful so as to violate an emissions mask imposed on wireless transmission by device 10.

In some scenarios, the wireless circuitry can reduce third order cross-intermodulation by implementing the mixer/PGA with circuitry that exhibits as high a linearity as possible. However, this can cause wireless circuitry 24 to consume excessive power during signal transmission, limiting the battery life of device 10. In other scenarios, the wireless circuitry can suppress the third order harmonic of the LO signal by reducing the duty cycle of the LO signal. However, this can require the LO circuitry to consume excessive power and to exhibit excessive complexity, cost, and/or area. In other scenarios, a passive filter can be disposed on the transmit path between the mixer circuitry and the non-linear component to filter out the third order harmonic of the LO signal prior to reaching the non-linear component. However, inductors and other components in the passive filter can consume an excessive amount of chip area and cost to the wireless circuitry. In other scenarios, the mixer circuitry can be implemented as a third order harmonic rejection mixer (HRM) that performs scaling (e.g., by the square root of two) on RF passive mixer paths to approximate the sinusoid waveform and suppress third order harmonics of the LO signal. However, this requires the mixer circuitry to always perform scaling by a ratio with the square root of two, limiting the flexibility of the mixer circuitry in performing signal transmission.

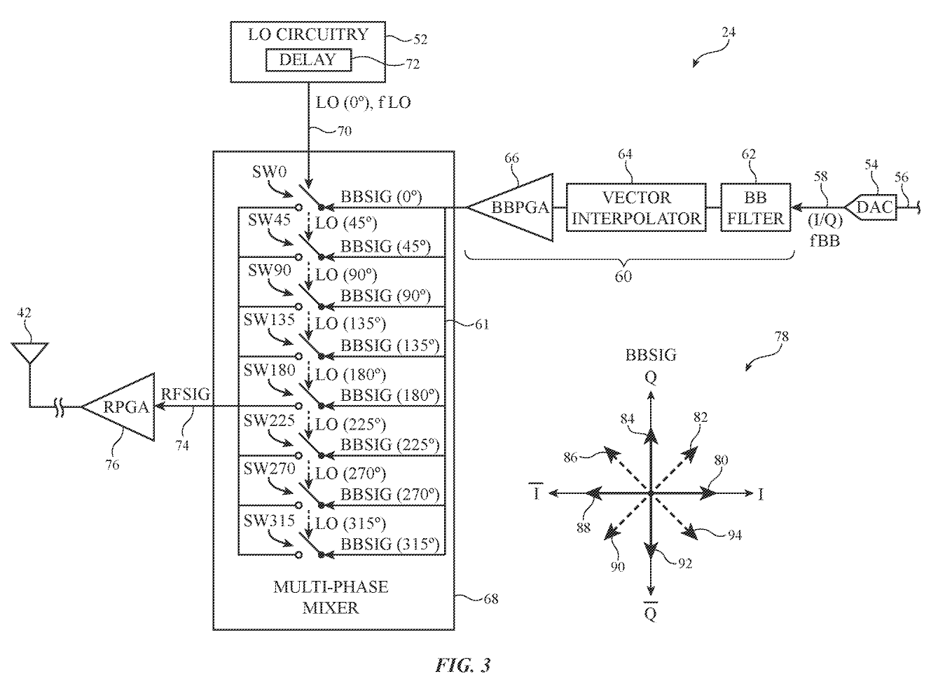

To mitigate these issues (e.g., minimizing device cost, area, and power consumption without sacrificing flexibility), the TX path in wireless circuitry 24 may include a vector interpolator that serves to eliminate or reduce CIM3, CIM5, and/or other spurious emissions. FIG. 3 is a circuit diagram showing one example of a TX path in wireless circuitry 24 that includes a vector interpolator for mitigating CIM3, CIM5, and/or HD3 emissions during signal transmission.

As shown in FIG. 3, the transmit path in wireless circuitry 24 may include digital-to-analog converter circuitry such as digital-to-analog converter (DAC) 54, analog baseband (ABB) circuitry 60, mixer circuitry such as multi-phase mixer 68, and a non-linear component such as a radio-frequency PGA (RPGA) 76 coupled to a corresponding antenna 42. ABB circuitry 60 may include filter circuitry such as baseband (BB) filter 62, vector interpolation circuitry such as vector interpolator 64, and amplifier circuity such as baseband PGA (BBPGA) 66. Multi-phase mixer 68 may be clocked using a corresponding local oscillator signal LO supplied by LO circuitry 52. Multi-phase mixer 68 may, for example, form part of mixer circuitry 50 of FIG. 2. The example of FIG. 3 in which the non-linear component includes RPGA 76 is illustrative and non-limiting and, in general, the non-linear component may include any desired non-linear circuits or non-linear components that exhibit non-linearity (e.g., a non-linear current or voltage characteristic). As other non-limiting examples, the non-linear component may include a power amplifier (PA), a polar amplifier, an operational amplifier, an inverter, another type of non-linear amplifier, a circuit containing one or more diodes, a circuit containing one or more transistors, a rectifier, a mixer, a modulator, a demodulator, a voltage stabilizer, a voltage regulator, non-linear switching circuitry, a non-linear transformer, a non-linear filter, etc.

If desired, DAC 54, ABB circuitry 60, multi-phase mixer 68, and/or RPGA 76 may be included within a radio-frequency transmitter of transceiver circuitry 28 (FIG. 2). DAC 54 and analog baseband circuitry 60 may be mounted to the same integrated circuit chip, package, or substrate (e.g., in processing circuitry 26 or transceiver circuitry 28 of FIG. 2). Multi-phase mixer 68 and/or RPGA 76 may be mounted to the same integrated circuit chip, package, or substrate as DAC 54 and ABB circuitry 60. Alternatively, one or both of multi-phase mixer 68 and RPGA 76 may be mounted to one or more additional integrated circuit chips, packages, or substrates.

The input of DAC 54 may be coupled to digital baseband circuitry (e.g., in processing circuitry 26 of FIG. 2) over digital baseband path 56. The output of DAC 54 may be coupled to the input of ABB circuitry 60 over analog baseband path 58. DAC 54 may receive digital baseband data over digital baseband path 56. DAC 54 may convert the digital baseband data into an analog baseband signal (sometimes also referred to herein as baseband signal DACSIG) on baseband path 58. DAC 54 may be, for example, an in-phase and quadrature-phase (I/Q) DAC and baseband path 58 may be an I/Q path. DAC 54 may output the analog baseband signal as an I/Q signal on baseband path 58 (e.g., where DAC 54 outputs the in-phase (I) component of the baseband signal onto an in-phase line in baseband path 58 and outputs the quadrature-phase (Q) component of the baseband signal onto a quadrature-phase line in baseband path 58). The baseband signal on baseband path 58 may be at a corresponding baseband frequency fBB.

In the example of FIG. 3, the input of BB filter 62 is communicatively coupled to the output of DAC 54 by baseband path 58. The output of BB filter 62 is coupled to the input of vector interpolator 64. The output of vector interpolator 64 is coupled to the input of BBPGA 66. The output of BBPGA 66 is communicatively coupled to a baseband input of multi-phase mixer 68 over baseband path(s) 61. Put differently, vector interpolator 64 may be coupled or interposed between BB filter 62 and BBPGA 66, BB filter 62 may be coupled or interposed between vector interpolator 64 and DAC 54, and BBPGA 66 may be coupled or interposed between vector interpolator 64 and multi-phase mixer 68. This is illustrative and non-limiting. In other implementations, BB filter 62 may be interposed between vector interpolator 64 and multi-phase mixer 68, vector interpolator 64 and BBPGA 66 may be combined into shared circuitry that integrates/combines the functionality of vector interpolator 64 and BBPGA 66, vector interpolator 64 and BB filter 62 may be combined into shared circuitry that integrates/combines the functionality of vector interpolator 64 and BB filter 62, or vector interpolator 64, BB filter 62, and BBPGA 66 may be combined into shared circuitry that integrates/combines the functionality of vector interpolator 64, BB filter 62, and BBPGA 66.

Multi-phase mixer 68 may include a set of switches SW coupled in parallel between the input of multi-phase mixer 68 (e.g., baseband path 61) and the output of multi-phase mixer 68 (e.g., radio-frequency transmission line path 74, which may form part of radio-frequency transmission line path 36 of FIG. 2). Each switch SW may, for example, have a respective first switch terminal communicatively coupled to baseband path(s) 61 and a respective second switch terminal communicatively coupled to radio-frequency transmission line path 74. The first and second terminals of a switch may be coupled together when the switch is on, active, or closed. The first and second terminals of a switch may be decoupled when the switch is off, inactive, or open. Each switch SW may be toggled by the local oscillator signal LO supplied by LO circuitry 52 over LO path 70 (e.g., one or more digital switch control paths). Radio-frequency transmission line path 74 may couple the output of multi-phase mixer 68 to the input of RPGA 76. The output of RPGA 76 may be communicatively coupled to antenna 42 (e.g., over a portion of radio-frequency transmission line path 36 of FIG. 2). Although antenna 42 may also be used to perform signal reception, if desired, FIG. 3 only illustrates a TX chain that performs signal transmission over antenna 42 for the sake of simplicity.

FIG. 3 also includes an I/Q plot 78 that illustrates the operation of the TX chain during signal transmission. Vector 80 in plot 78 represents the in-phase (I) component of the baseband signal supplied by DAC 54 to ABB circuitry 60. Vector 88 in plot 78 represents an inverse of the I component of the baseband signal supplied by DAC 54 to ABB circuitry 60. Vector 84 in plot 78 represents the quadrature-phase (Q) component of the baseband signal supplied by DAC 54 to ABB circuitry 60. Vector 92 in plot 78 represents the inverse of the Q component of the baseband signal supplied by DAC 54 to ABB circuitry 60. Vectors 80, 84, 88, and 92 may collectively represent four possible phases of the baseband signal that may be supplied to multi-phase mixer 68 (e.g., at zero, 90, 180, and 270 degrees respectively). BB filter 62 may perform filtering on the baseband signal to pass a filtered baseband signal to vector interpolator 64.

Vector interpolator 64 is sometimes also referred to as phase intermodulator 64. Vector interpolator 64 may perform 45-degree vector (phase) interpolation (e.g., vector addition/summation) on the I/Q vectors in the filtered baseband signal received from BB filter 62 to produce up to four additional baseband components in the baseband signal that is eventually supplied to multi-phase mixer 68. Each baseband component interpolated by vector interpolator 64 is supplied by vector interpolator 64 with a different respective phase and is represented by a different respective interpolated vector in plot 78 (e.g., where each interpolated vector is oriented at a different respective angle in plot 78).

For example, as shown in plot 78, vector interpolator 64 may generate a first interpolated component of the baseband signal, represented by a first interpolated vector 82 that is rotated at 45 degrees with respect to I vector 80 (e.g., by performing vector interpolation on the components of the filtered baseband signal represented by vectors 80 and 84). Vector interpolator 64 may generate a second interpolated component of the baseband signal, represented by a second interpolated vector 86 that is rotated at 135 degrees with respect to I vector 80 (e.g., by performing vector interpolation on the components of the filtered baseband signal represented by vectors 84 and 88). Vector interpolator 64 may generate a third interpolated component of the baseband signal, represented by a third interpolated vector 90 that is rotated at 225 degrees with respect to I vector 80 (e.g., by performing vector interpolation on the components of the filtered baseband signal represented by vectors 88 and 92). Vector interpolator 64 may generate a fourth interpolated component of the baseband signal, represented by a fourth interpolated vector 94 that is rotated at 315 degrees with respect to I vector 80 (e.g., by performing vector interpolation on the components of the filtered baseband signal represented by vectors 92 and 80). Vectors 80, 84, 88, and 92 are non-interpolated vectors, where vector 84 is at a 90 degree angle with respect to vector 80, vector 88 is at a 180 degree angle with respect to vector 80, and vector 92 is at a 270 degree angle with respect to vector 80.

BBPGA 66 may amplify the baseband signal output by vector interpolator 64 to produce baseband signal BBSIG. Baseband signal BBSIG may have eight components at different respective phases (e.g., eight equally-spaced phases separated by 45 degrees), where each component is represented by a respective one of the eight vectors 80-94 in plot 78. ABB circuitry 60 may supply baseband signal BBSIG to the baseband input of multi-phase mixer 68 over baseband path(s) 61. Because baseband signal BBSIG has eight components represented by eight different vectors 80-94, multi-phase mixer 68 may be implemented as an eight-phase mixer having eight switches SW coupled in parallel between baseband path(s) 61 and radio-frequency transmission line path 74. Each switch SW may receive a different respective phase of the baseband signal (e.g., a different respective vector in plot 78) from ABB circuitry 60.

For example, the multi-phase mixer 68 may include eight switches SW such as switches SW0, SW45, SW90, SW135, SW180, SW225, SW270, and SW315 coupled in parallel between baseband path(s) 61 and radio-frequency transmission line path 74. Switch SW0 may receive a first component of baseband signal BBSIG at a phase of zero degrees (e.g., represented by vector 80). Switch SW45 may receive a second component of baseband signal BBSIG at an interpolated phase of 45 degrees (e.g., represented by interpolated vector 82) relative to the phase of the baseband signal BBSIG received by switch SW0. Switch SW90 may receive a third component of baseband signal BBSIG at a phase of 90 degrees (e.g., represented by vector 84). Switch SW135 may receive a fourth component of baseband signal BBSIG at an interpolated phase of 135 degrees (e.g., represented by interpolated vector 86). Switch SW180 may receive a fifth component of baseband signal BBSIG at a phase of 180 degrees (e.g., represented by vector 88). Switch SW225 may receive a sixth component of baseband signal BBSIG at an interpolated phase of 225 degrees (e.g., represented by interpolated vector 90). Switch SW270 may receive a seventh component of baseband signal BBSIG at a phase of 270 degrees (e.g., represented by vector 92). Switch SW315 may receive an eighth component of baseband signal BBSIG at an interpolated phase of 315 degrees (e.g., represented by interpolated vector 94).

Local oscillator circuitry 52 may generate and output local oscillator signal LO at frequency fLO on LO path 70. LO path 70 may, for example, supply local oscillator signal LO to control terminals of switches SW0-SW315. When local oscillator signal LO is asserted at a logic high level at the control terminal of a switch SW, the switch may be turned on, activated, or closed. When local oscillator signal LO is asserted at a logic low level at the control terminal of a switch SW, the switch may be turned off, deactivated, or opened. In a simple example, each switch SW may include a respective transistor having a first source-drain terminal communicatively coupled to baseband path(s) 61, a second source-drain terminal communicatively coupled to radio-frequency transmission line path 74, and a gate terminal coupled to LO path 70 (e.g., where the gate terminal forms the control terminal of the switch).

The term “activate” with respect to a switch (or transistor) may refer to or be defined herein as an action that places the switch in an “on”or low-impedance state such that the two terminals of the switch are electrically connected to conduct current. Activating a switch can sometimes be referred to as turning on or closing a switch. The term “deactivate” with respect to a switch (or transistor) may refer to or be defined herein as an action that places the switch in an “off” or high-impedance state such that the two terminals of the switch/transistor are electrically disconnected with minimal leakage current. Deactivating a switch can sometimes be referred to as turning off or opening a switch.

Local oscillator circuitry 52 may supply local oscillator signal LO to each of switches SW0-SW315 with the same magnitude but with a different respective phase for each switch. For example, local oscillator circuitry 52 may include delay circuitry 72 or other circuitry that generates local oscillator signal LO at the same magnitude but with eight different, equally spaced, phases with respect to each other. LO circuitry 52 may supply a different respective one of the phases of local oscillator signal LO to the control terminal of each of switches SW0-SW315. The eight phases of local oscillator signal LO are each separated by 45 degrees.

For example, as shown in FIG. 3, local oscillator circuitry 52 may supply a first phase of local oscillator signal LO (at a phase of zero degrees) to switch SW0 over LO path 70. Local oscillator circuitry 52 may supply a second phase of local oscillator signal LO (at a phase of 45 degrees relative to the first phase) to switch SW45 over LO path 70. Local oscillator circuitry 52 may supply a third phase of local oscillator signal LO (at a phase of 90 degrees relative to the first phase) to switch SW90 over LO path 70. Local oscillator circuitry 52 may supply a fourth phase of local oscillator signal LO (at a phase of 135 degrees relative to the first phase) to switch SW135 over LO path 70. Local oscillator circuitry 52 may supply a fifth phase of local oscillator signal LO (at a phase of 180 degrees relative to the first phase) to switch SW180 over LO path 70. Local oscillator circuitry 52 may supply a sixth phase of local oscillator signal LO (at a phase of 225 degrees relative to the first phase) to switch SW225 over LO path 70. Local oscillator circuitry 52 may supply a seventh phase of local oscillator signal LO (at a phase of 270 degrees relative to the first phase) to switch SW270 over LO path 70. Local oscillator circuitry 52 may supply an eighth phase of local oscillator signal LO (at a phase of 315 degrees relative to the first phase) to switch SW315s over LO path 70. All eight phases of local oscillator signal LO may be received by its corresponding switch at the same magnitude.

Each phase of local oscillator signal LO may toggle the state of its corresponding switch while that switch concurrently receives its respective component (phase) of baseband signal BBSIG (e.g., where a switch SW passes its component/phase of baseband signal BBSIG onto the output of multi-phase mixer 68 when the switch is on and does not pass its component/phase of baseband signal BBSIG onto the output of multi-phase mixer when the switch is off). The collective toggling of switches SW0-SW315 by the eight phases of local oscillator signal LO at frequency fLO may serve to effectively upconvert baseband signal BBSIG to radio-frequencies (e.g., mixing the eight phases of the baseband signal with eight corresponding equal magnitude phases of the local oscillator signal), producing radio-frequency signal RFSIG at the output of multi-phase mixer 68 (e.g., a voltage signal at a time-varying voltage V_{RF} on radio-frequency transmission line path 74). Radio-frequency transmission line path 74 may convey radio-frequency signal RFSIG to RPGA 76, which amplifies radio-frequency signal RFSIG for transmission over antenna 42. The vector interpolation performed by vector interpolator 64 and the corresponding phasing of local oscillator signal LO at multi-phase mixer 68 may serve to prevent the formation of signal components in radio-frequency signal RFSIG that would otherwise produce CIM3, CIM5, and/or other emissions after amplification of the radio-frequency signal by RPGA 76.

Each harmonic of local oscillator signal LO may be represented by a corresponding integer m (e.g., where the frequency of each harmonic is given by m*fLO). Each harmonic of baseband signal BBSIG may be represented by a corresponding integer n (e.g., where the frequency of each harmonic is given by n*fBB). Assuming m + n for upper sideband conversion as an SOI tone, spurious emissions of the baseband signal mixed with the local oscillator signal (e.g., frequencies m*fLO mixed with frequencies n*fBB) will be canceled out after upconversion by multi-phase mixer 68 and thus will be absent from the output of RPGA 76 when the following condition is met: (m – n)π/4 = +/- (2k +1)π, where k is an integer. This condition can be simplified to the condition (m – n) = +/- 4, 12, etc. This condition is met, for example, when m = 1 and n = -3, which corresponds to CIM3 emission at frequency fLO – 3fBB, when m = 1 and n = 5, which corresponds to CIM5 emission at frequency fLO + 5fBB, when m = 3 and n = -1 (corresponding to emissions at a frequency of 3fLO - fBB), when m = 5 and n = 1 (corresponding to emissions at a frequency of 5fLO + fBB), etc. As can be seen, the condition is met for both CIM3 and CIM5 emission, effectively mitigating CIM3 and CIM5 power from deteriorating the performance of the TX path. In this way, the TX path can mitigate the effects of spurious emissions without the need for a passive filter between multi-phase mixer 68 and RPGA 76, helping to reduce the chip area required to implement the TX path. The cancellation of these spurious emissions may also allow RPGA 76 to be implemented with relaxed linearity requirements, which can reduce the power consumption of wireless circuitry 24 and can extend the batter life of device 10.

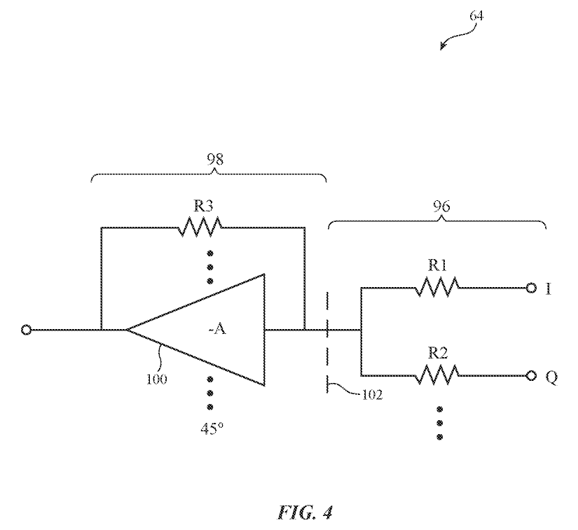

FIG. 4 is a circuit block diagram showing one possible implementation for the vector interpolator (VI) 64 in ABB circuitry 60. As shown in FIG. 4, VI 64 may include voltage-to-current converting circuitry 96 and current-to-voltage converting circuitry 98 coupled in series between voltage-to-current converting circuitry 96 and the output of VI 64. Voltage-to-current converting circuitry 96 is sometimes also referred to herein as voltage-to-current converting stage 96. Current-to-voltage converting circuitry 98 is sometimes also referred to herein as current-to-voltage converting stage 98. Voltage-to-current converting circuitry 96 may be coupled in series between current-to-voltage converting circuitry 98 and baseband path 58 (FIG. 3). Current-to-voltage converting circuitry 98 may include, for example, amplifier circuitry (e.g., a set of one or more inverters, operational amplifiers, etc.) and a feedback resistor R3 coupled between the input and output of amplifier circuitry 100. Voltage-to-current converting circuitry 96 may include, for example, a set of one or more resistors R1 coupled between the in-phase line of baseband path 58 and the input of amplifier circuitry 100. Voltage-to-current converting circuitry 96 may also include a set of one or more resistors R2 coupled between the quadrature-phase line of baseband path 58 and the input of amplifier circuitry 100.

During signal transmission, four different components (phases) of the baseband signal (e.g., represented by vectors 80, 84, 88, and 92 in plot 78 of FIG. 3) may be supplied to voltage-to-current converting circuitry 96 over the baseband path. Voltage-to-current converting circuitry 96 may convert the components of the baseband signal from voltage signals into corresponding current signals at interface 102. Current-to-voltage converting circuitry 98 may convert the current signals back to voltage signals by the ratio of the resistances in VI 64, which outputs the baseband signal from VI 64 as a voltage signal. Current-to-voltage converting circuity 98 may also serve to interpolate, using the four components of the baseband signal received from voltage-to-current converting circuitry 96 (e.g., represented by vectors 80, 84, 88, and 92), four new (interpolated) components of the baseband signal at 45 degree angles with respect to the four components of the baseband signal received from voltage-to-current converting circuitry 96. The four interpolated components of the baseband signal are represented by interpolated vectors 82, 86, 90, and 94 in plot 78 of FIG. 3. In this way, VI 64 may effectively convert the four-phase baseband (I/Q) signal into an interpolated eight-phase baseband signal that is supplied to BBPGA 66 and multi-phase mixer 68 (e.g., baseband signal BBSIG of FIG. 3, having eight phases equally separated by 45 degrees and represented by vectors 80-94 in plot 78 of FIG. 3). The example of FIG. 4 in which vector interpolator 64 performs 45 degree vector (phase) interpolation is illustrative and non-limiting. In general, vector interpolator 64 in any of embodiments or combination of embodiments described herein may perform vector (phase) interpolation by any desired angles or amounts (e.g., 60 degree interpolation, 30 degree interpolation, interpolation by another angle between 30-60 degrees, 20-70 degrees, 10-80 degrees, etc.). The resistances of resistors R1, R2, and/or R3 may, for example, be set to configure vector interpolator 64 to perform a desired amount of interpolation on the I/Q signals (vectors) received at its input. In implementations where one or both resistances are implemented using one or more corresponding programmable attenuators, for example, control signals provided to the attenuators may set and adjust the resistances of resistors R1, R2, and/or R3 to set, change, and/or update the amount (angles) of interpolation performed by vector interpolator 64 over time. Multi-phase mixer 68 (FIG. 3) may include corresponding switches that each receive a respective phase of the output of the vector interpolator (e.g., baseband signal BBSIG of FIG. 3), where each switch is toggled by the same corresponding phase of local oscillator signal LO.

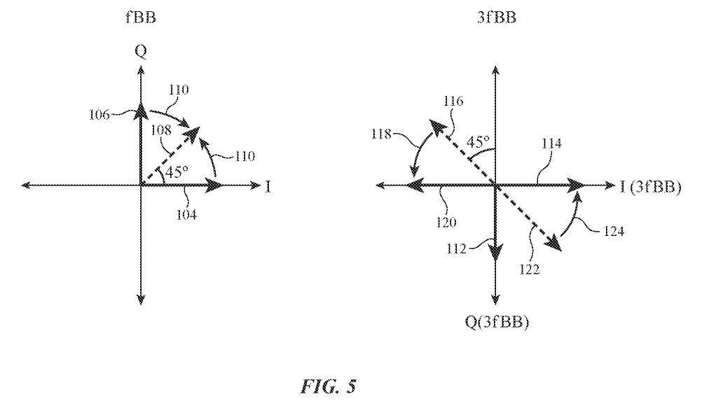

FIG. 5 includes I/Q plots illustrating how VI 64 may serve to cancel out CIM3 emissions for the TX path. The left I/Q plot in FIG. 5 illustrates the interpolation of a baseband signal component at a phase of 45 degrees and at frequency fBB by VI 64 when the non-linear circuit components of the TX path are coupled between the VI and the antenna. For example, as shown by arrows 110, VI 64 may generate vector 108 at 45 degrees by interpolating (e.g., performing vector addition on) vector 106 and vector 104 of the baseband signal received from the DAC.

The right I/Q plot in FIG. 5 illustrates interpolation at the frequency 3fBB associated with production of CIM3 emissions. Vector 122 in FIG. 5 illustrates an interpolated vector generated by the VI from vectors 112 and 114 of the incident baseband signal in implementations where the non-linear circuit components of the TX path are coupled between the VI and the DAC (e.g., vector 122 is generated from I/Q components of the third order harmonic of the baseband frequency). When the baseband signal component represented by vector 122 is upconverted by the multi-phase mixer, the multi-phase mixer adds an additional 45 degree phase shift to the component, as shown by arrow 124, aligning the shifted vector to vector 114 and preventing cancellation of the signal component represented by vector 114 after output from the mixer. On the other hand, vector 116 illustrates a corresponding interpolated vector (for the third order harmonic frequency 3fBB) generated by the VI but when the non-linear circuit components of the TX path are coupled between the VI and the antenna (e.g., as shown in FIG. 3). When the baseband signal component represented by vector 116 is upconverted by multi-phase mixer 68, the multi-phase mixer adds an additional 45 degree phase shift to the component, as shown by arrow 118. This shifts vector 116 to vector 120. Vector 120 is of equal magnitude but opposite direction from vector 114, causing vector 120 to cancel out vector 114, removing the power of the third order harmonic from the signal and preventing formation of CIM3 emissions after operation on the signal by the non-linear component(s) of the TX path (e.g., RPGA 76 of FIG. 3).

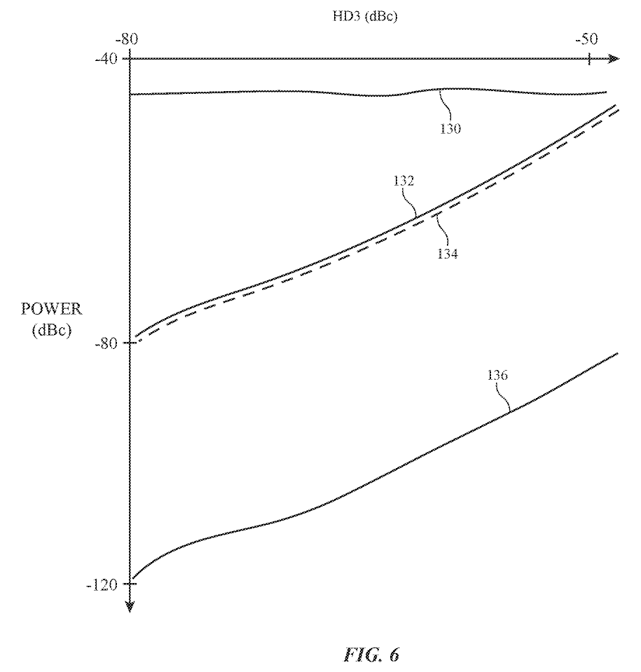

FIG. 6 plots signal power (in dBc) as a function of different HD3 powers (in dBc) of ABB circuitry 60 prior to vector summing (e.g., at interface 102 of FIG. 4). Curve 130 plots the output of RPGA 76 at frequency 3fLO in the absence of 3fLO – fBB cancellations by VI 64 and multi-phase mixer 68. As shown by curve 130, this power level remains relatively high, which can deteriorate or limit performance of the TX path. Curve 136 plots the output of RPGA 76 at frequencies associated with CIM5 emission with mitigation by VI 64 and multi-phase mixer 68. As shown by curve 136, this power level remains relatively low (e.g., substantially lower than the powers associated with curve 130), helping to ensure that the TX path exhibits satisfactory performance.

Dashed curve 134 plots the output of multi-phase mixer 68 at frequencies associated with CIM3 emission and curve 132 plots the output of RPGA 76 at the same frequencies associated with CIM3 emission, with mitigation by VI 64 and multi-phase mixer 68. As shown by curves 132 and 134, the cancellation of the 3fLO – fBB component in the signal causes the output of RPGA 76 to closely track the output of mixer 68. This is because the mitigation performed by the VI and multi-phase mixer removes the signal component of radio-frequency signal RFSIG that would otherwise cause the RPGA to output the radio-frequency signal with a relatively high amount of power at frequencies associated with CIM3 emission (e.g., the VI’s third order harmonic distortion is canceled). The example of FIG. 6 is illustrative and, in practice, curves 130-136 may have other shapes.

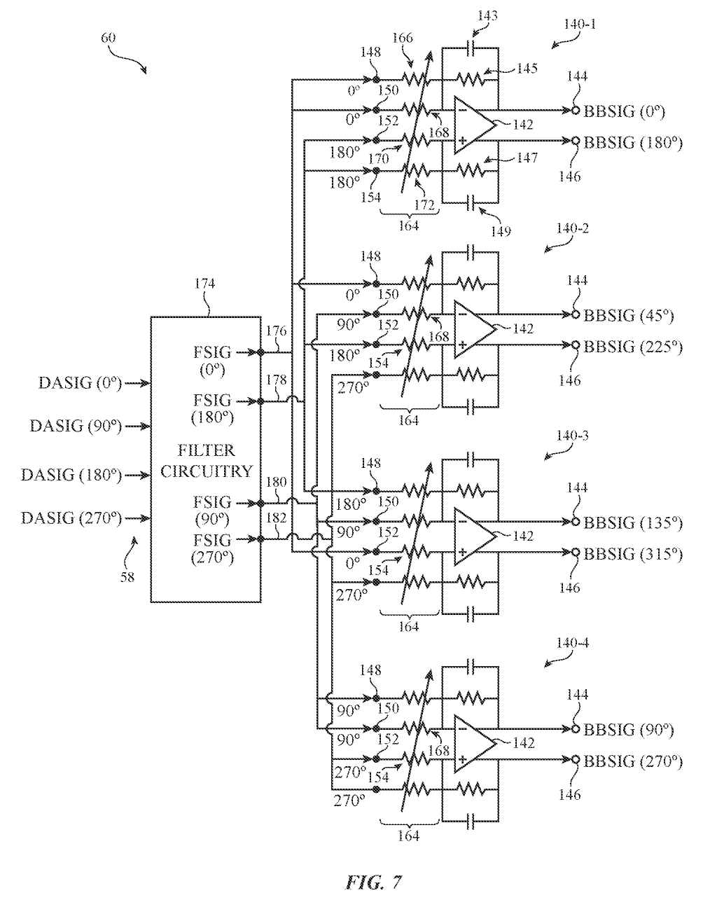

If desired, to help conserve chip area in ABB circuitry 60, VI 64, and BBPGA 66 may be combined or integrated into the same circuitry that performs the operations of both VI 64 and BBPGA 66. FIG. 7 is a circuit diagram showing one example of how VI 64 and BBPGA 66 may be combined or integrated into the same circuitry that performs the operations of VI 64 and BBPGA 66. As shown in FIG. 7, ABB circuitry 60 may include a set of circuit blocks 140 such as circuit blocks 140-1, 140-2, 140-3, and 140-4. Each circuit block 140 may perform the operations of VI 64 and BBPGA 66. Each circuit block 140 may include a respective amplifier 142. Each amplifier 142 may be, for example, an operational amplifier having a first (e.g., negative) input, a second (e.g., positive) input, a first (e.g., negative) output, and a second (e.g., positive) output. The first output of amplifier 142 may be coupled to a first output terminal 144 of the corresponding circuit block 140. The second output of amplifier 142 may be coupled to a second output terminal 146 of the corresponding circuit block 140. The first input of amplifier 142 may be communicatively coupled to a first input terminal 148 and a second input terminal 150 of the corresponding circuit block 140. The second input of amplifier 142 may be communicatively coupled to a third input terminal 152 and a fourth input terminal 154 of the corresponding circuit block 140.

Each circuit block 140 may include a first feedback resistor 145 and a first feedback capacitor 143 coupled in parallel between the first input and the first output of the amplifier 142 in that circuit block 140. Each circuit block 140 may also include a second feedback resistor 147 and a second feedback capacitor 149 coupled in parallel between the second input and the second output of the amplifier 142 in that circuit block 140. Each circuit block 140 may include a respective programmable attenuator 164 coupled between the input of that circuit block 140 and the amplifier 142 in that circuit block 140. Each programmable attenuator 164 may include a respective resistor bank that includes a first resistor 166, a second resistor 168, a third resistor 170, and a fourth resistor 172. Resistor 166 may couple input terminal 148 to the first input of amplifier 142. Resistor 168 may couple input terminal 150 to the first input of amplifier 142. Resistor 170 may couple input terminal 152 to the second input of amplifier 142. Resistor 172 may couple input terminal 154 to the second input of amplifier 142. Resistors 166-172 may be programmable or adjustable resistors that are controlled to tune the amount of signal attenuation between the input terminals and amplifier 142 of the corresponding circuit block 140.

The four programmable attenuators 164 shown in FIG. 7 may collectively form voltage-to-current converting circuitry 96 of FIG. 4 (e.g., the resistors 166-172 in circuit blocks 140 may collectively form the sets of resistors R1 and R2 in FIG. 4). Put differently, the four programmable attenuators 164 may collectively perform the operations of voltage-to-current converting circuitry 96 of FIG. 4. The four amplifiers 142 and the corresponding feedback resistors 145 and/or 147 may collectively form current-to-voltage converting circuitry 98 of FIG. 4 while the four amplifier 142 and the corresponding feedback resistors 145 and 147 and the corresponding feedback capacitors 143 and 149 also collectively and concurrently form BBPGA 66 of FIG. 3. Put differently, the four amplifiers 142 and the corresponding feedback resistors 145 and 147 and feedback capacitors 143 and 149 may collectively perform the operations of both current-to-voltage converting circuitry 98 of FIG. 4 and BBPGA 66 of FIG. 3. This may serve to minimize area consumption in ABB circuitry 60.

As shown in FIG. 7, ABB circuitry 60 may also include filter circuitry 174 (e.g., forming BB filter 62 of FIG. 3) coupled between baseband path 58 and circuit blocks 140. Circuit blocks 140 may be coupled in parallel between filter circuitry 174 and baseband path(s) 61 of FIG. 3. The output terminal 144 of circuit block 140-1 may be communicatively coupled to switch SW0 of FIG. 3 (e.g., over a first baseband path 61). The output terminal 146 of circuit block 140-1 may be communicatively coupled to switch SW180 of FIG. 3 (e.g., over a second baseband path 61). The output terminal 144 of circuit block 140-2 may be communicatively coupled to switch SW45 of FIG. 3 (e.g., over a third baseband path 61). The output terminal 146 of circuit block 140-2 may be communicatively coupled to switch SW225 of FIG. 3 (e.g., over a fourth baseband path 61). The output terminal 144 of circuit block 140-3 may be communicatively coupled to switch SW135 of FIG. 3 (e.g., over a fifth baseband path 61). The output terminal 146 of circuit block 140-3 may be communicatively coupled to switch SW315 of FIG. 3 (e.g., over a sixth baseband path 61). The output terminal 144 of circuit block 140-4 may be communicatively coupled to switch SW90 of FIG. 3 (e.g., over a seventh baseband path 61). The output terminal 146 of circuit block 140-4 may be communicatively coupled to switch SW270 of FIG. 3 (e.g., over an eighth baseband path 61).

Filter circuitry 174 may have a first input terminal that receives a first component of a baseband signal DACSIG output by DAC 54 (FIG. 3) onto baseband path 58 at a phase of zero degrees (e.g., represented by vector 80 in FIG. 3). Filter circuitry 174 may have a second input terminal that receives a second component of the baseband signal DACSIG on baseband path 58 at a phase of 90 degrees (e.g., represented by vector 84 in FIG. 3). Filter circuitry 174 may have a third input terminal that receives a third component of the baseband signal DACSIG on baseband path 58 at a phase of 180 degrees (e.g., represented by vector 88 in FIG. 3). Filter circuitry 174 may have a fourth input terminal that receives a fourth component of the baseband signal DACSIG on baseband path 58 at a phase of 270 degrees (e.g., represented by vector 92 in FIG. 3).

Filter circuitry 174 may filter the first component of baseband signal DACSIG at zero degrees to generate a first filtered signal FSIG at zero degrees. Filter circuitry 174 may filter the third component of baseband signal DACSIG at 180 degrees to generate a second filtered signal FSIG at 180 degrees. Filter circuitry 174 may filter the third component of baseband signal DACSIG at 90 degrees to generate a third filtered signal FSIG at 90 degrees. Filter circuitry 174 may filter the fourth component of baseband signal DACSIG at 270 degrees to generate a fourth filtered signal FSIG at 270 degrees.

Filter circuitry 174 may output the first filtered signal FSIG (with a phase of zero degrees) at a first output terminal that is coupled to signal path 176. Signal path 176 may couple the first output terminal of filter circuitry 174 to input terminals 148 and 150 of circuit block 140-1, to input terminal 148 of circuit block 140-2, and to input terminal 152 of circuit block 140-3 in parallel. Signal path 176 may concurrently convey the first filtered signal FSIG at zero degrees to input terminals 148 and 150 of circuit block 140-1, input terminal 148 of circuit block 140-2, and input terminal 152 of circuit block 140-3.

Filter circuitry 174 may output the second filtered signal FSIG (with a phase of 180 degrees) at a second output terminal that is coupled to signal path 178. Signal path 178 may couple the second output terminal of filter circuitry 174 to input terminals 152 and 154 of circuit block 140-1, to input terminal 152 of circuit block 140-2, and to input terminal 148 of circuit block 140-3 in parallel. Signal path 178 may concurrently convey the second filtered signal FSIG at 180 degrees to input terminals 152 and 154 of circuit block 140-1, input terminal 152 of circuit block 140-2, and input terminal 148 of circuit block 140-3.

Filter circuitry 174 may output the third filtered signal FSIG (with a phase of 90 degrees) at a third output terminal that is coupled to signal path 180. Signal path 180 may couple the third output terminal of filter circuitry 174 to input terminals 148 and 150 of circuit block 140-4, to input terminal 150 of circuit block 140-3, and to input terminal 150 of circuit block 140-2 in parallel. Signal path 180 may concurrently convey the third filtered signal FSIG at 90 degrees to input terminals 148 and 150 of circuit block 140-4, input terminal 150 of circuit block 140-3, and input terminal 150 of circuit block 140-2.

Filter circuitry 174 may output the fourth filtered signal FSIG (with a phase of 270 degrees) at a fourth output terminal that is coupled to signal path 182. Signal path 182 may couple the fourth output terminal of filter circuitry 174 to input terminals 152 and 154 of circuit block 140-4, to input terminal 154 of circuit block 140-3, and to input terminal 154 of circuit block 140-2 in parallel. Signal path 182 may concurrently convey the fourth filtered signal FSIG at 270 degrees to input terminals 152 and 154 of circuit block 140-4, input terminal 154 of circuit block 140-3, and input terminal 154 of circuit block 140-2.

Circuit block 140-1 may generate the first component of baseband signal BBSIG at zero degrees and may generate the fifth component of baseband signal BBSIG at 180 degrees using the first filtered signal FSIG at zero degrees and the second filtered signal FSIG at 180 degrees received from filter circuitry 174. Circuit block 140-1 may output the first component of baseband signal BBSIG at zero degrees (e.g., represented by vector 80 in FIG. 3) at its output terminal 144, which supplies the first component of baseband signal BBSIG to switch SW0 of multi-phase mixer 68. Circuit block 140-1 may output the fifth component of baseband signal BBSIG at 180 degrees (e.g., represented by vector 88 in FIG. 3) at its output terminal 146, which supplies the fifth component of baseband signal BBSIG to switch SW180 of multi-phase mixer 68.

At the same time, circuit block 140-2 may generate the second component of baseband signal BBSIG at 45 degrees (e.g., represented by vector 82 in FIG. 3) and may generate the sixth component of baseband signal BBSIG at 225 degrees (e.g., represented by vector 90 in FIG. 3) using the first filtered signal FSIG at zero degrees received at its input terminal 148, the third filtered signal FSIG at 90 degrees received via its input terminal 150, the second filtered signal FSIG at 180 degrees received via its input terminal 152, and the fourth filtered signal FSIG at 270 degrees received via its input terminal 154. Circuit block 140-2 may generate the second component of baseband signal BBSIG at 45 degrees at its output terminal 144 by performing vector interpolation (phase intermodulation) on the first filtered signal FSIG at zero degrees and the third filtered signal FISG at 90 degrees. The output terminal 144 of circuit block 140-2 may supply the second component of baseband signal BBSIG at 45 degrees to switch SW45 of multi-phase mixer 68. Circuit block 140-2 may generate the sixth component of baseband signal BBSIG at 225 degrees by performing vector interpolation (phase intermodulation) on the second filtered signal FSIG at 180 degrees and the fourth filtered signal FISG at 270 degrees. The output terminal 146 of circuit block 140-2 may supply the sixth component of baseband signal BBSIG at 225 degrees to switch SW225 of multi-phase mixer 68.

At the same time, circuit block 140-3 may generate the fourth component of baseband signal BBSIG at 135 degrees (e.g., represented by vector 86 in FIG. 3) and may generate the eighth component of baseband signal BBSIG at 315 degrees (e.g., represented by vector 94 in FIG. 3) using the second filtered signal FSIG at 180 degrees received at its input terminal 148, the third filtered signal FSIG at 90 degrees received via its input terminal 150, the first filtered signal FSIG at 0 degrees received via its input terminal 152, and the fourth filtered signal FSIG at 270 degrees received via its input terminal 154. Circuit block 140-3 may generate the fourth component of baseband signal BBSIG at 135 degrees at its output terminal 144 by performing vector interpolation (phase intermodulation) on the second filtered signal FSIG at 180 degrees and the third filtered signal FISG at 90 degrees. The output terminal 144 of circuit block 140-3 may supply the fourth component of baseband signal BBSIG at 135 degrees to switch SW135 of multi-phase mixer 68. Circuit block 140-3 may generate the eighth component of baseband signal BBSIG at 135 degrees by performing vector interpolation (phase intermodulation) on the first filtered signal FSIG at 0 degrees and the fourth filtered signal FISG at 270 degrees. The output terminal 146 of circuit block 140-3 may supply the eighth component of baseband signal BBSIG at 315 degrees to switch SW315 of multi-phase mixer 68.

At the same time, circuit block 140-4 may generate the third component of baseband signal BBSIG at 90 degrees and may generate the seventh component of baseband signal BBSIG at 270 degrees using the third filtered signal FSIG at 90 degrees and the fourth filtered signal FSIG at 270 degrees received from filter circuitry 174. Circuit block 140-4 may output the third component of baseband signal BBSIG at 90 degrees (e.g., represented by vector 84 in FIG. 3) at its output terminal 144, which supplies the third component of baseband signal BBSIG to switch SW90 of multi-phase mixer 68. Circuit block 140-4 may output the seventh component of baseband signal BBSIG at 270 degrees (e.g., represented by vector 92 in FIG. 3) at its output terminal 146, which supplies the seventh component of baseband signal BBSIG to switch SW270 of multi-phase mixer 68. The example of FIG. 7 is illustrative and non-limiting and, in general, circuit blocks 140 may be implemented using other architectures.

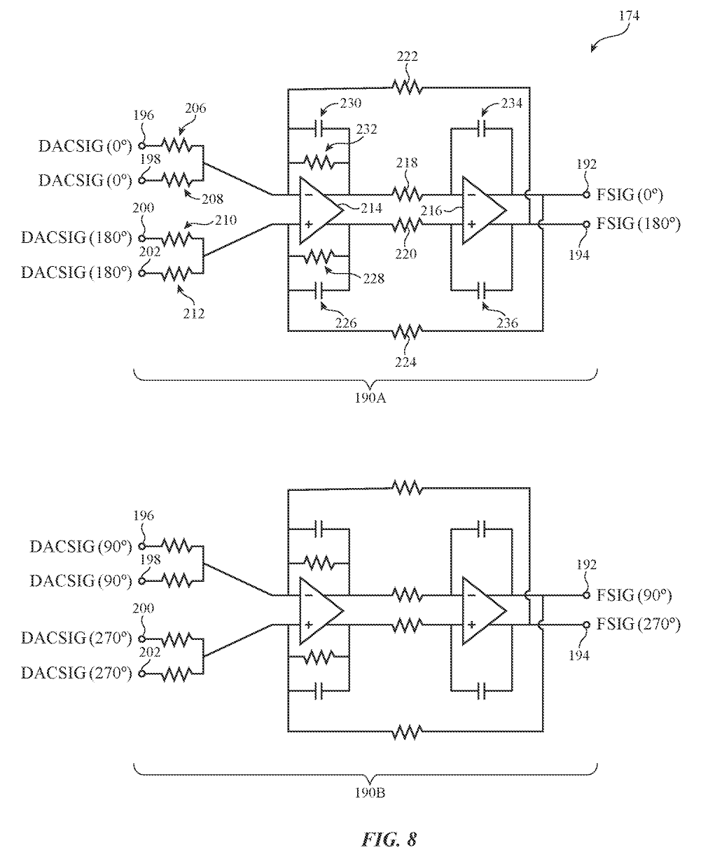

Filter circuitry 174 may be implemented using any desired filter architecture. In some implementations that are described herein as a non-limiting example, filter circuitry 174 may include a Tow-Thomas bi-quad filter. FIG. 8 is a circuit diagram showing one example of how filter circuitry 174 may be implemented using a Tow-Thomas bi-quad filter. As shown in FIG. 8, filter circuitry 174 may include a first filter 190A and a second filter 190B. Each of filters 190A and 190B may include a first amplifier 214 (e.g., a first operational amplifier) and a second amplifier 216 (e.g., a second operational amplifier) coupled in series between an input of the filter and an output of the filter. The input of the filter may include input terminals 196, 198, 200, and 202. The output of the filter may include output terminals 192 and 194.

Each of filters 190A and 190B may also include a feedback resistor 232 and a feedback capacitor 230 coupled in parallel between the first (e.g., negative) input and the first (e.g., negative) output of amplifier 214, a feedback resistor 228 and a feedback capacitor 226 coupled in parallel between the second (e.g., positive) input and the second (e.g., positive) output of amplifier 214, a feedback capacitor 234 coupled between the first (e.g., negative) input and the first (e.g., negative) output of amplifier 216, and a feedback capacitor 236 coupled between the second (e.g., positive) input and the second (e.g., positive) output of amplifier 216. Each of filters 190A and 190B may also include a first resistor 218 coupled in series between the first output of amplifier 214 and the first input of amplifier 216, a second resistor 220 coupled in series between the second output of amplifier 214 and the second input of amplifier 216, a third resistor 222 coupled between the first input of amplifier 214 and the second output of amplifier 216, and a fourth resistor 224 coupled between the second input of amplifier 214 and the first output of amplifier 216. The first output terminal 192 of each of filters 190A and 190B may be coupled to the first output of the amplifier 216 in that filter. The second output terminal 194 of each of filters 190A and 190B may be coupled to the second output of the amplifier 216 in that filter.

Each of filters 190A and 190B may also include a first resistor 206 coupled between input terminal 196 and the first input of amplifier 214, a second resistor 208 coupled between input terminal 198 and the first input of amplifier 214, a third resistor 210 coupled between input terminal 200 and the second input of amplifier 214, and a fourth resistor 212 coupled between input terminal 202 and the second input of amplifier 214. The output terminal 192 of filter 190A may be coupled to signal path 176 of FIG. 7. The output terminal 194 of filter 190A may be coupled to signal path 178 of FIG. 7. The output terminal 192 of filter 190B may be coupled to signal path 180 of FIG. 7. The output terminal 194 of filter 190B may be coupled to signal path 182 of FIG. 7.

Filter 190A may receive baseband signal DACSIG at a phase of zero degrees at its input terminals 196 and 198 and may receive baseband signal DACSIG at a phase of 180 degrees at its input terminals 200 and 202 (e.g., from DAC 54 via one or more in-phase lines in baseband path 58 of FIG. 3). Filter 190A may filter the zero degree phase and/or the 180 degree phase of baseband signal DACSIG to generate the first filtered signal FSIG (at zero degrees) at its output terminal 192. Filter 190A may filter the zero degree phase and/or the 180 degree phase of baseband signal DACSIG to generate the second filtered signal FSIG (at 180 degrees) at its output terminal 194.

Filter 190B may receive baseband signal DACSIG at a phase of 90 degrees at its input terminals 196 and 198 and may receive baseband signal DACSIG at a phase of 270 degrees at its input terminals 200 and 202 (e.g., from DAC 54 via one or more quadrature phase lines in baseband path 58 of FIG. 3). Filter 190B may filter the 90 degree phase and/or the 270 degree phase of baseband signal DACSIG to generate the third filtered signal FSIG (at 90 degrees) at its output terminal 192. Filter 190B may filter the 90 degree phase and/or the 270 degree phase of baseband signal DACSIG to generate the fourth filtered signal FSIG (at 270 degrees) at its output terminal 194.

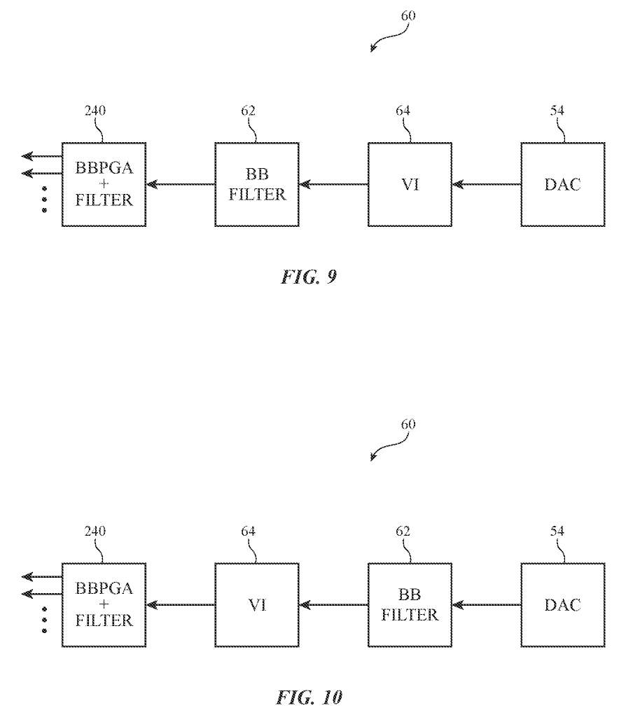

The example of FIG. 8 is illustrative and non-limiting and, if desired, filter circuitry 174 may be implemented using other filter circuits. FIG. 9 shows another implementation for ABB circuitry 60 in which VI 64 is coupled between the output of DAC 54 and the input of BB filter 62. As shown in FIG. 9, BB filter 62 (e.g., a bi-quad filter such as filter circuitry 174 in FIG. 8) may be coupled between VI 64 and a circuit 240 that performs the functions of BBPGA 66 (FIG. 3) as well as additional filtering (e.g., circuit 240 is a combined/integrated BBPGA and filter). In these implementations, for example, the filter in circuit 240 may be a passive filter that includes resistive and capacitive components, and VI 64 may be implemented using phase intermodulator circuitry and low signal swing SF circuitry, if desired. These implementations may perform passive phase intermodulation with improved HD3 gain/phase performance over process variations for cancellation but can consume excessive area and can cause BB filter 62 to consume excessive power.

The example of FIG. 9 is illustrative and non-limiting. If desired, as shown in FIG. 10, BB filter 62 may be coupled between VI 64 and DAC 54 instead of between DAC 64 and circuit 240. These implementations may perform passive phase intermodulation with improved HD3 gain/phase performance over process variations for cancellation but can still consume excessive power and/or area, with linearity limited to 60 dB or similar. The implementation in FIGS. 3-8 in which VI 64 is coupled between BB filter 62 and BBPGA 66 and in which VI 64 is optionally integrated together with the BBPGA (e.g., in circuit blocks 140 of FIG. 7) consumes less power and area than the implementations of FIGS. 9 and 10 while still exhibiting sufficient amounts of spurious emission mitigation.

Using one or more of the implementations described herein, the TX path in wireless circuitry 24 may include an 8-phase LO/BB transmitter with an 8-phase vector interpolation circuit that effectively cancels out CIM3, CIM5, 3fLO, and/or 5fLO spurious emissions without requiring a 3fLO passive filter. If desired, the 8-phase vector interpolation circuit may be integrated or embedded into the filter of BBPGA 66 (e.g., in circuit blocks 140 of FIG. 7) to further save area and/or power. At the same time, HD3 of the 8-phase vector interpolator can be canceled out for fLO – 3fBB (CIM3) spurious emission.

The methods and operations described above in connection with FIGS. 1-10 may be performed by the components of device 10 using software, firmware, and/or hardware (e.g., dedicated circuitry or hardware). Software code for performing these operations may be stored on non-transitory computer readable storage media (e.g., tangible computer readable storage media) stored on one or more of the components of device 10 (e.g., storage circuitry 16 and/or wireless circuitry 24 of FIG. 1). The software code may sometimes be referred to as software, data, instructions, program instructions, or code. The non-transitory computer readable storage media may include drives, non-volatile memory such as non-volatile random-access memory (NVRAM), removable flash drives or other removable media, other types of random-access memory, etc. Software stored on the non-transitory computer readable storage media may be executed by processing circuitry on one or more of the components of device 10 (e.g., processing circuitry in wireless circuitry 24, processing circuitry 18 or control circuitry 14 of FIG. 1, etc.). The processing circuitry may include microprocessors, application processors, digital signal processors, central processing units (CPUs), application-specific integrated circuits with processing circuitry, or other processing circuitry.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is illustrative and various modifications can be made to the described embodiments. The foregoing embodiments may be implemented individually or in any combination.

What is claimed is:

1. Wireless circuitry comprising:
a digital-to-analog converter (DAC);
a vector interpolator having an input communicatively coupled to an output of the DAC;
a multi-phase mixer having an input communicatively coupled to an output of the vector interpolator; and
a non-linear component having an input communicatively coupled to an output of the multi-phase mixer.

2. The wireless circuitry of claim 1, wherein the multi-phase mixer comprises a set of switches coupled in parallel between the output of the vector interpolator and the input of the non-linear component.

3. The wireless circuitry of claim 2, further comprising:
local oscillator circuitry configured to generate a local oscillator signal and configured to supply the local oscillator signal to each switch in the set of switches at a same magnitude and at a different respective phase.

4. The wireless circuitry of claim 3, wherein the DAC is configured to supply first, second, third, and fourth phases of a baseband signal to the vector interpolator, the vector interpolator is configured to generate fifth, sixth, seventh, and eighth phases of the baseband signal based on the first, second, third, and fourth phases of the baseband signal, and wherein the multi-phase mixer is configured to generate a radio-frequency signal, supplied to the input of the non-linear component, based on the first, second, third, fourth, fifth, sixth, seventh, and eighth phases of the baseband signal and eight corresponding phases of the local oscillator signal.

5. The wireless circuitry of claim 4, wherein the first, second, third, fourth, fifth, sixth, seventh, and eighth phases are equally separated by 45 degrees and wherein the eight corresponding phases of the local oscillator signal are equally separated by 45 degrees.

6. The wireless circuitry of claim 4, wherein the non-linear component comprises a radio-frequency programmable gain amplifier (RPGA) configured to amplify the radio-frequency signal.

7. The wireless circuitry of claim 1, further comprising:
a baseband programmable gain amplifier coupled between the output of the vector interpolator and the input of the multi-phase mixer.

8. The wireless circuitry of claim 7, further comprising:
a baseband filter coupled between the output of the DAC and the input of the vector interpolator.

9. The wireless circuitry of claim 8, wherein the baseband filter comprises a Tow-Thomas bi-quad filter.

10. The wireless circuitry of claim 1, wherein the vector interpolator comprises:
a voltage-to-current converting stage having an input communicatively coupled to the output of the DAC; and
a current-to-voltage converting stage coupled between the voltage-to-current converting stage and the input of the multi-phase mixer.

11. Wireless circuitry comprising:
a digital-to-analog converter configured to output an in-phase and quadrature-phase (I/Q) baseband signal;
a vector interpolator communicatively coupled to an output of the DAC and configured to output eight phases of a baseband signal based on the (I/Q) baseband signal;
a radio-frequency amplifier;
a multi-phase mixer that includes a set of eight switches coupled in parallel between the vector interpolator and the radio-frequency amplifier, wherein each switch in the set of eight switches is configured to receive a different respective one of the eight phases of the baseband signal output by the vector interpolator; and
local oscillator circuitry configured to generate eight equal magnitude phases of a local oscillator signal, wherein each switch in the set of eight switches is toggled by a different respective one of the eight equal magnitude phases of the local oscillator signal.

12. The wireless circuitry of claim 11, wherein the eight phases of the baseband signal output by the vector interpolator are equally spaced by 45 degrees.

13. The wireless circuitry of claim 12, wherein the eight equal magnitude phases of the local oscillator signal are equally spaced by 45 degrees.

14. The wireless circuitry of claim 11, wherein the vector interpolator comprises:
a first amplifier having a first output communicatively coupled to a first switch in the set of eight switches and having a second output communicatively coupled to a second switch in the set of eight switches;
a second amplifier having a third output communicatively coupled to a third switch in the set of eight switches and having a fourth output communicatively coupled to a fourth switch in the set of eight switches;
a third amplifier having a fifth output communicatively coupled to a fifth switch in the set of eight switches and having a sixth output communicatively coupled to a sixth switch in the set of eight switches; and
a fourth amplifier having a seventh output communicatively coupled to a seventh switch in the set of eight switches and having an eighth output communicatively coupled to an eighth switch in the set of eight switches.

15. The wireless circuitry of claim 14, wherein:
the first amplifier is configured to output a first phase of the baseband signal at the first output,
the first amplifier is configured to output a second phase of the baseband signal at the second output, the second phase being 180 degrees from the first phase,
the second amplifier is configured to output a third phase of the baseband signal at the third output, the third phase being 45 degrees from the first phase,
the second amplifier is configured to output a fourth phase of the baseband signal at the fourth output, the fourth phase being 225 degrees from the first phase,
the third amplifier is configured to output a fifth phase of the baseband signal at the fifth output, the fifth phase being 135 degrees from the first phase,
the third amplifier is configured to output a sixth phase of the baseband signal at the sixth output, the sixth phase being 315 degrees from the first phase,
the fourth amplifier is configured to output a seventh phase of the baseband signal at the seventh output, the seventh phase being 90 degrees from the first phase, and
the fourth amplifier is configured to output an eighth phase of the baseband signal at the eighth output, the eighth phase being 270 degrees from the first phase.

16. The wireless circuitry of claim 15, further comprising:
a first programmable attenuator coupled to an input of the first amplifier;
a second programmable attenuator coupled to an input of the second amplifier;
a third programmable attenuator coupled to an input of the third amplifier;
a fourth programmable attenuator coupled to an input of the fourth amplifier; and
filter circuitry communicatively coupled between the output of the DAC and the vector interpolator, the filter circuitry being configured to generate first, second, third, and fourth filtered signals based on the I/Q baseband signal, wherein
the second filtered signal is 180 degrees from the first filtered signal,
the third filtered signal 90 degrees from the first filtered signal,
the fourth filtered signal is 270 degrees from the first filtered signal,
the filter is configured to supply the first and second filtered signals to the first programmable attenuator,
the filter circuitry is configured to supply the first, second, third, and fourth filtered signals to the second programmable attenuator and to the third programmable attenuator, and
the filter circuitry is configured to supply the third and fourth filtered signals to the fourth programmable attenuator.

17. The wireless circuitry of claim 16, wherein the filter circuitry comprises a Tow-Thomas bi-quad filter.

18. The wireless circuitry of claim 16, wherein:
the first switch is toggled by a first phase of the local oscillator signal,
the second switch is toggled by a second phase of the local oscillator signal that is 180 degrees from the first phase of the local oscillator signal,
the third switch is toggled by a third phase of the local oscillator signal that is 45 degrees from the first phase of the local oscillator signal,
the fourth switch is toggled by a fourth phase of the local oscillator signal that is 225 degrees from the first phase of the local oscillator signal,
the fifth switch is toggled by a fifth phase of the local oscillator signal that is 135 degrees from the first phase of the local oscillator signal,
the sixth switch is toggled by a sixth phase of the local oscillator signal that is 315 degrees from the first phase of the local oscillator signal,
the seventh switch is toggled by a seventh phase of the local oscillator signal that is 90 degrees from the first phase of the local oscillator signal, and
the eighth switch is toggled by an eighth phase of the local oscillator signal that is 270 degrees from the first phase of the local oscillator signal.

19. A radio-frequency transmitter comprising:
a baseband filter configured to output four different phases of a baseband signal;
a vector interpolator communicatively coupled to the baseband filter and configured to output eight different phases of the baseband signal based on the four different phases of the baseband signal output by the baseband filter, wherein the eight different phases of the baseband signal are equally separated by 45 degrees; and
an eight-phase mixer communicatively coupled to the vector interpolator and configured to generate a radio-frequency signal based on the eight different phases of the baseband signal and eight different equal magnitude phases of a local oscillator signal, wherein the eight different equal magnitude phases of the local oscillator signal are equally separated by 45 degrees.

20. The radio-frequency transmitter of claim 19, further comprising:
a baseband programmable gain amplifier coupled between the vector interpolator and the eight-phase mixer and configured to amplify the eight different phases of the baseband signal; and
a radio-frequency programmable gain amplifier coupled to an output of the eight-phase mixer and configured to amplify the radio-frequency signal.
